(19) United States
(12) Patent Application Publication
(10) Pub. No.: US 2020/0210874 A1
(43) Pub. Date: Jul. 2, 2020

(54) METHOD AND SYSTEM FOR THE CREATION OF FUZZY COGNITIVE MAPS FROM EXTRACTED CONCEPTS

(71) Applicant: Meraglim Holdings, Grand Cayman (KY)

(72) Inventors: John T. Rickard, Larkspur, CO (US); James Rickards, Portsmouth, NH (US); David G. Morgenthaler, Lakewood, CO (US)

(73) Assignee: Meraglim Holdings, Grand Cayman (KY)

(21) Appl. No.: 16/690,120

(22) Filed: Nov. 21, 2019

Related U.S. Application Data
(60) Provisional application No. 62/785,823, filed on Dec. 28, 2018.

(51) Int. Cl. G06N 7/02; G06F 16/904

(52) U.S. Cl. CPC G06N 7/02; G06F 16/904

(57) ABSTRACT

The present invention is a computer-implemented method for generating a cognitive map, comprising: identifying, by one or more processors, a subject matter node, wherein it is determined if the subject matter is pre-exiting in a cognitive map; incorporating, by one or more processors, the subject matter node into the cognitive map; establishing, by one or more processors, a relationship between the subject matter node and the pre-existing nodes, where the relationship is determined based on the subject matter node relative to the pre-existing nodes; categorizing, by one or more processors, the subject matter node as an exogenous or a non-exogenous node; and generating, by one or more processors, a graphical representation of the cognitive map.

### CROSS-REFERENCE TO RELATED APPLICATIONS

This application is a continuation-in-part (and claims the benefit of priority under 35 USC 120) of U.S. application No. 62/785,823 filed Dec. 28, 2018. The disclosure of the prior applications is considered part of (and is incorporated by reference in) the disclosure of this application.

### BACKGROUND

This disclosure relates generally to the creation of fuzzy cognitive maps (FCMs) in a Computing with Words (CWW) architecture for the purpose of predictions, wherein all node states and link strengths in the FCM are represented using words drawn from specified vocabularies. The combination of these features is denoted as a FCM/CWW system, and refers more specifically to a method, computer program and computer system for generating the FCM from a corpus of written or verbal expert narratives from which concepts and linkages between concepts are extracted, instantiating the FCM elements with word-based states and word-based link strengths, designating the form of word-based aggregation functions for the positively and/or negatively causal inputs to each FCM node, iterating the FCM to a convergence point, and generating a forecast based on the converged iterations, which is generally represented in the form of pseudo-probability distributions over the output vocabulary words of particular nodes. The initial step of creating the cognitive maps may be performed manually by subject matter experts (SMEs) or with the aid of artificial intelligence (AI) methods including, e.g., natural language processing (NLP).

Cognitive mapping techniques as an analytical tool can be used in various information systems development and implementation activities. The three major cognitive mapping techniques include causal mapping, semantic mapping, and concept mapping. A causal map represents a set of causal relationships among constructs within a belief system. Semantic mapping, also known as idea mapping, is used to explore an idea without the constraints of a superimposed structure. Concept mapping is a graphical representation in which nodes represent concepts and links represent the positively or negatively causal relationships between concepts. Cognitive mapping techniques have been proposed to be applied in predictive analysis.

Of the cognitive mapping techniques, FCM/CWW systems are used iteratively to compute, for a given set of inputs to certain “exogenous” nodes, the converged activations of the remaining nodes that comprise the cognitive map, in a manner that explicitly accounts for imprecision in one's knowledge of the node states and link strengths between various nodes in the architecture of the map. FCM/CWW techniques generalize and extend this approach by representing this imprecision in the form of words drawn from appropriate vocabularies. Artificial intelligence algorithmic techniques are used to perform the necessary calculations for the propagation of word-based representations of node states through the FCM/CWW architecture during the iterations leading to convergence, and also are used to calculate the probability distributions over the output word vocabularies of selected nodes.

Mathematically, FCM/CWW models are nonlinear dynamical systems represented by a collection of concepts, the pairwise link strengths describing the various positively or negatively causal relations that exist between pairs of concepts and the nonlinear aggregation functions used to determine the respective activation states of the concepts at each iteration. The concepts correspond to the FCM/CWW nodes and the causal relationships are represented by directed and signed links between pairs of nodes. Each FCM/CWW link is accompanied by a word that defines the (imprecise) strength of the causal relation between a pair of nodes. The sign of a link specifies whether the state of the source node has a positively or negatively causal impact on the state of its destination node. The composite inputs to each node are aggregated to determine the strength of activation of that node.

Certain of the FCM/CWW nodes in a given cognitive map are exogenous in the sense that that have no in-links from other nodes in the map, and thus their word states are determined from external information sources, which may include market data and/or news feeds, NLP, SMEs, outputs of other cognitive maps, or in general any source of external information. Given a set of exogenous node input states in the form of words, the FCM/CWW is iterated multiple times, holding the exogenous states fixed, until the remaining non-exogenous node states achieve converged word values, or more generally, a converged probability distribution over their respective word values. This probability distribution provides valuable predictive analysis of the corresponding output states of the non-exogenous nodes.

### SUMMARY

In a first embodiment, the present invention is a computer-implemented method for generating a cognitive map, comprising: identifying, by one or more processors, a subject matter node, wherein it is determined if the subject matter is pre-exiting in a cognitive map; incorporating, by one or more processors, the subject matter node into the cognitive map; establishing, by one or more processors, a relationship between the subject matter node and the pre-existing nodes, where the relationship is determined based on the subject matter node relative to the pre-existing nodes; categorizing, by one or more processors, the subject matter node as an exogenous or a non-exogenous node; and generating, by one or more processors, a graphical representation of the cognitive map.

In a second embodiment, the present invention is a computer program product, the computer program product comprising a computer readable storage medium having program instructions embodied therewith, the program instructions executable by a computing device to cause the computing device to: review a piece of source material, wherein it is determined by one or more subject matter experts if the piece of source material has at least one relevant subject matter; incorporating the at least one relevant subject matter into a cognitive map, determining a correlation between the at least one relevant subject matter and the pre-existing subject matters in the cognitive map; and generating a visual representation of the cognitive map.

In a third embodiment, the present invention is a system comprising: a CPU, a computer readable memory and a computer readable storage medium associated with a computing device; program instructions to receive knowledge and information related to a subject from at least one subject matter expert; program instructions to incorporate the subject into a cognitive map, wherein the subject is identified as a node, and it is determined that the subject is not previously incorporated into the cognitive map; program instructions to connect the node with pre-existing nodes in the cognitive map based on the knowledge and information received from the at least one subject matter expert; program instructions to amend the connections between the nodes in the cognitive map; and program instructions to generate a visual representation of the cognitive map.

### BRIEF DESCRIPTION OF THE DRAWINGS

Referring now to the drawings in which like reference numbers represent corresponding parts throughout:

FIG. 1 depicts a representative computer system/server node implementation according to an embodiment of the present invention.

FIG. 2 depicts a cloud computing environment according to an embodiment of the present invention.

FIG. 3 depicts abstraction model layers according to an embodiment of the present invention.

FIG. 4 depicts a block diagram depicting a computing environment according to an embodiment of the present invention.

FIG. 5 depicts a flowchart of the operational steps taken by cognitive mapping module to generate a map using a computing device within the computing environment of FIG. 1 according to an embodiment of the present invention.

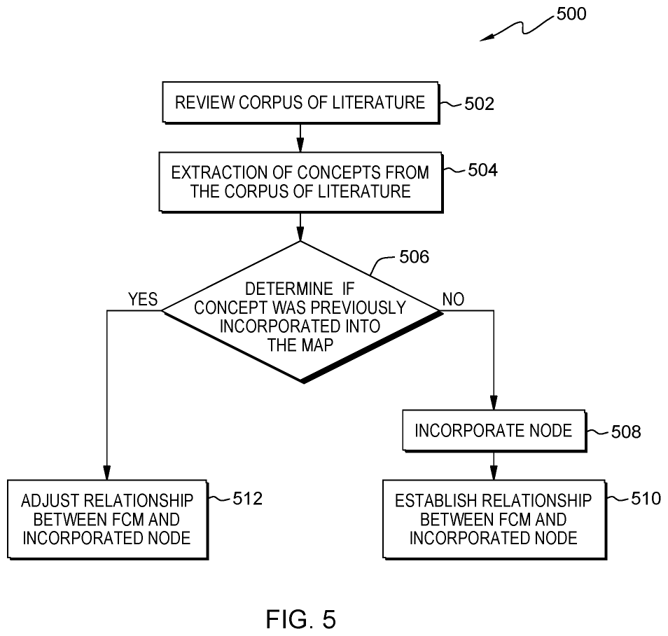

FIG. 6 depicts a diagram of a map, in accordance with an embodiment of the present invention.

### DETAILED DESCRIPTION

The present invention generally relates to a system and method for generating a cognitive map (CM) using both human intelligence and computer learning to analyze literature and determine the association between the pieces of literature to generate the CM.

Through the use of both expert reviews and analysis of the literature and the computer learning systems, the information, topics, and connections that are incorporated into the CM are stronger and more relevant than would be the case for just a computer learning system. The expert reviews provide an invaluable understanding and analysis of the pieces of literature to create a stronger and more relevant connection between the various nodes of the CM. The CM is then able to be used for a multitude of calculations and predictions.

The invention represents a method and apparatus for creating cognitive maps CMs from a corpus of literature describing a particular real-world domain, to include in particular global macro-economic domains, but not restricted to the latter domains. These cognitive maps are instrumented using computing with words (CWW) technology that enables the use of words from appropriate vocabularies to describe the activation states of each node and the positively or negatively causal relations between the nodes. The use of words as opposed to scalar values reflects the inherent imprecisions in these variables, which is typical of real-world applications. The aggregation functions used in the CMs enable the modeling of a large range of aggregation behaviors, including those characteristic of critical threshold phenomena. For a set of exogenous concept activations, the CMs are iterated until convergence is obtained. The converged activations of the non-exogenous concept nodes are represented by normalized distributions of word similarities over their corresponding vocabularies of output words, in the form of pseudo-probability distributions, thus providing predictive analysis of the states of these nodes resulting from the given inputs.

As described herein, existing systems do not solve the technical problems associated with using scalar values or even type-1 fuzzy membership functions when creating and employing the CMs in real-world situations. Such representations are unable to convey the inherent imprecision of current and real-world events and facts that the present invention proves to solve. To begin, consider the query, “What is the state of China/Russia relations?” Clearly the answer cannot adequately be described using a scalar or even some precise functional representation, as it involves an imprecise judgment. However, it is relatively straightforward to answer such a query using a descriptive word or phrase selected from a vocabulary of choices that might range over terms from one extreme to another, such as, e.g., “at war”, “hostile”, . . . , “neutral”, . . . , “friendly”, “very friendly”. A contribution to answering this query might be derived from a document containing the text, “An agreement to cooperate on trade settled in yuan or rubles was announced by the governments of China and Russia.” This is where Computing with Words, Natural Language Processing, SMEs and unsupervised machine learning come into play. Assigning a descriptive term to this query involves assembling and analyzing information from a multiplicity of sources, either by machine or SME analysis or both, and the final state assigned is inherently imprecise. Therefore, the state itself must be expressed using an imprecise representation, i.e., a word.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowcharts may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the flowchart illustrations, and combinations of blocks in the flowchart illustrations, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

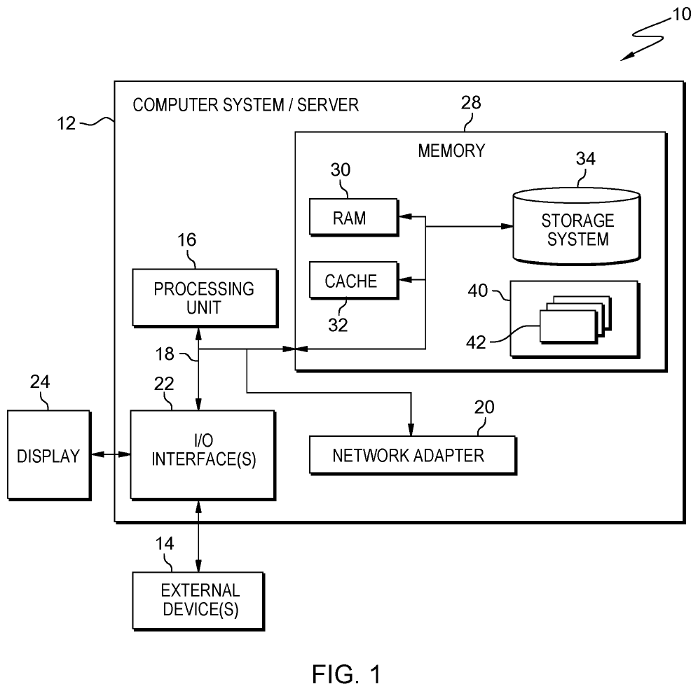

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purposes or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random-access memory (RAM) 30 and/or cache memory 32. Computer system/server 12 may further include other removable/non-removable, volatile/non-volatile computer system storage media. By way of example only, storage system 34 can be provided for reading from and writing to a nonremovable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to microcode, device drivers, redundant processing units, external disk drive arrays, RAID systems, tape drives, and data archival storage systems, etc.

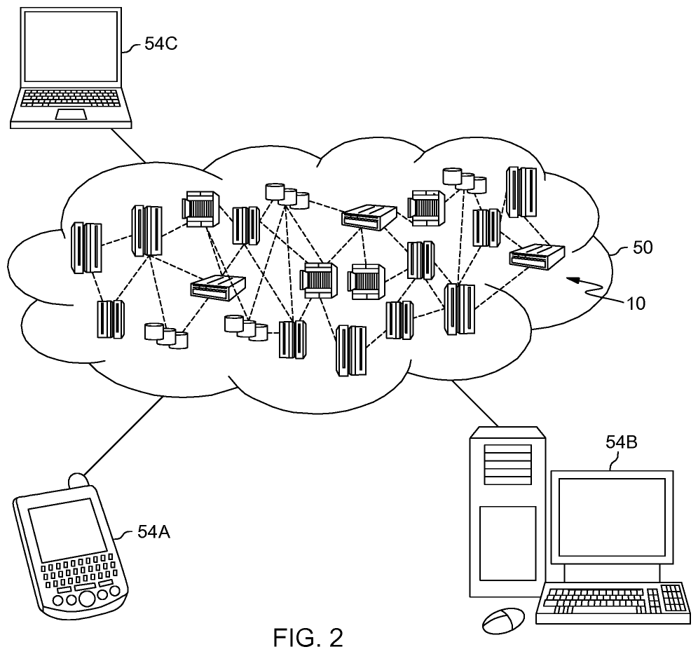

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Cloud computing nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that cloud computing nodes 10 and cloud computing environment 50 can communicate with any type of computerized device over any type of network and/or network addressable connection (e.g., using a web browser).

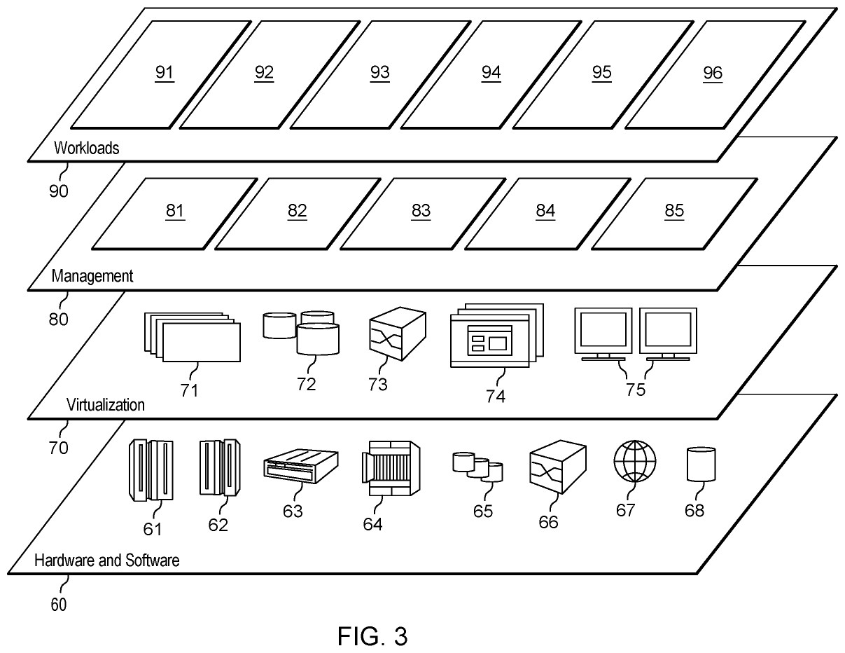

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 include hardware and software components. Examples of hardware components include mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include mapping and navigation 91; software development and lifecycle management 92; virtual classroom education delivery 93; data analytics processing 94; transaction processing 95; and parking space selection 96.

Referring back to FIG. 1, the Program/utility 40 may include one or more program modules 42 that generally carry out the functions and/or methodologies of embodiments of the invention as described herein.

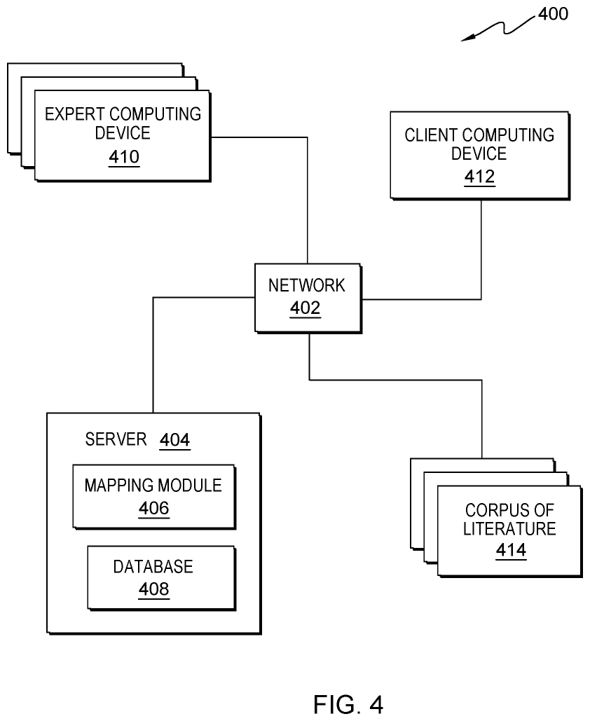

FIG. 4 depicts a block diagram of a computing environment 400 in accordance with one embodiment of the present invention. FIG. 1 provides an illustration of one embodiment and does not imply any limitations regarding the environment in which different embodiments maybe implemented.

FIG. 1 depicts a block diagram of a computing environment 400 in accordance with one embodiment of the present invention. FIG. 1 provides an illustration of one embodiment and does not imply any limitations regarding the environment in which different embodiments maybe implemented. In the depicted embodiment, computing environment 400 includes network 402, server 404, expert computing devices 410, client computing device 412, and corpus of literature 414. Computing environment 400 may include additional servers, computers, or other devices not shown.

Network 402 may be a local area network (LAN), a wide area network (WAN) such as the Internet, any combination thereof, or any combination of connections and protocols that can support communications between server 404, expert computing devices 410, client computing device 412, and corpus of expert narratives 414 in accordance with embodiments of the invention. Network 402 may include wired, wireless, or fiber optic connections. The network 402 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 402 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 402 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

Expert computing device(s) 410 comprise one or more computing devices which can receive input from an information source and transmit and receive data via network 402. The expert computing device 410 may be any other electronic device or computing system capable of processing program instructions and receiving and sending data. In one embodiment, the expert computing device 410 is a conventional computer system executing, for example, a Microsoft Windows compatible operating system (OS), Apple OS X, and/or a Linux distribution. In another embodiment, the expert computing device 410 can be a device having computer functionality, such as a smart-phone, a tablet, a personal digital assistant (PDA), a mobile telephone, etc. In some embodiments, expert computing device 410 may be a laptop computer, tablet computer, netbook computer, personal computer (PC), a desktop computer, or any programmable electronic device capable of communicating with server 404, client computing device 412, and corpus of expert narratives 414 via network 402. In other embodiments, the expert computing device 410 may represent a server computing system utilizing multiple computers as a server system, such as in a cloud computing environment. In another embodiment, the expert computing device 410 represents a computing system utilizing clustered computers and components to act as a single pool of seamless resources.

Client computing device(s) 412 comprise one or more computing devices which can receive input from a user and transmit and receive data via network 402. The client computing device 412 may be any other electronic device or computing system capable of processing program instructions and receiving and sending data. In one embodiment, the client computing device 412 is a conventional computer system executing, for example, a Microsoft Windows compatible operating system (OS), Apple OS X, and/or a Linux distribution. In another embodiment, the client computing device 412 can be a device having computer functionality, such as a smart-phone, a tablet, a personal digital assistant (PDA), a mobile telephone, etc. In some embodiments, client computing device 412 may be a laptop computer, tablet computer, netbook computer, personal computer (PC), a desktop computer, or any programmable electronic device capable of communicating with server 404, expert computing device 410, and corpus of literature 414 via network 402. In other embodiments, the client computing device 412 may represent a server computing system utilizing multiple computers as a server system, such as in a cloud computing environment. In another embodiment, the client computing device 412 represents a computing system utilizing clustered computers and components to act as a single pool of seamless resources.

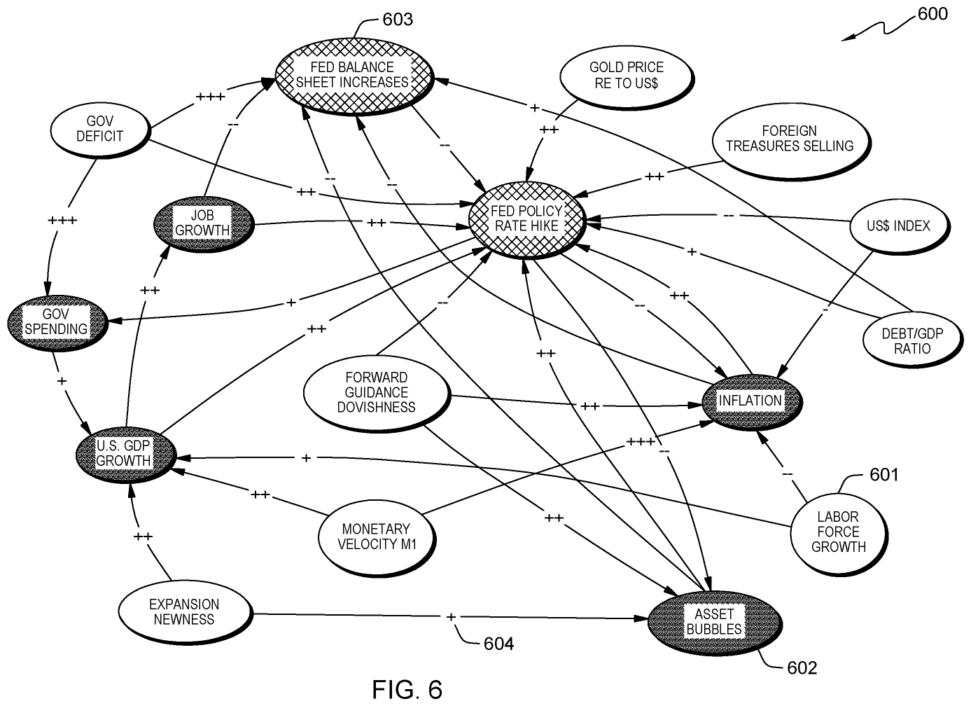

The client computing device 412 works with the cognitive computing mapping module 406 to retrieve the data and optimizes the data to enhance the user experience and provide a visualization that is both user friendly and descriptive of the data which is to be depicted. The module 406 may have visualization applications that convert the data, to improve upon the visualization of the data and thereby improve the user experience. FIG. 6 depicts an example of a visualization of the data to improve the user experience. The presented data allows the user to execute a number of functions and commands to interact with the user interface. The user interface may take on various forms and embodiments based on the client, the preferred aesthetics, and the desired level of interaction.

Corpus of expert narratives 414 includes one or more pieces of content that is related to a topic selected by the expert computing device 410, the client computing device 412, or the cognitive mapping module 406. The corpus of literature 414 comprise a corpus of literature which may include, but is not limited to, any textual, graphical, pictorial (images or videos), audio, or the like, which may contain information or data related to the selected topic. This can include articles, reports, web pages, presentations, interviews, audio recording, databases, or any piece of information work (or data) with the intention of relating information in a presentable form which is accessible by network 402. In some embodiments, hard copies of these sources may be located and used, and the information stored in database 408 through various means of transferred the material to virtual data.

Database 408 may be a repository that may be written to and/or read by expert computing device 410 or cognitive mapping module 406. Data collected by the expert computing device 410, topics selected by the client computing device 412, all or portions of the sources, as well as other data generated by the cognitive mapping module 406 may be stored in database 408. In one embodiment, database 408 is a database management system (DBMS) used to allow the definition, creation, querying, update, and administration of a database(s). In the depicted embodiment, database 408 resides within server 404. In other embodiments, database 408 resides on another server, or another computing device, provided that database 408 is accessible by cognitive mapping module 406 and expert computing devices 410 and their components.

Server 404 may be a management server, a web server, or any other electronic device or computing system capable of processing program instructions and receiving and sending data. In another embodiments server 404 may be a laptop computer, tablet computer, netbook computer, personal computer (PC), a desktop computer, or any programmable electronic device capable of communicating via network 402. In one embodiment, server 404 may be a server computing system utilizing multiple computers as a server system, such as in a cloud computing environment. In one embodiment, server 404 represents a computing system utilizing clustered computers and components to act as a single pool of seamless resources. In the depicted embodiment cognitive mapping module 406 and database 408 are located on server 404.

Cognitive mapping module 406 functions to generating the FCM/CWW system from a corpus of expert narratives and SME analysis, including the steps of designating a corresponding set of word vocabularies and representations for describing the possible activation levels of each node and the strength of each link, instantiating the FCM/CWW elements with word-based states and word-based link strengths, designating the form of word-based aggregation functions for the inputs to each FCM/CWW node, iterating the FCM/CWW to a convergence point, and generating a forecast based on the converged iterations. The vocabularies may be determined by the cognitive mapping module 406, a third party, or a computer learning algorithm. The FCM/CWW systems are instrumented using computing with words technology that enables the use of words from appropriate vocabularies to describe the activation states of specific nodes and the positively or negatively causal relations between the nodes. The choice of aggregation functions used in the different nodes enables the modeling of a large range of behaviors, including those characteristic of critical threshold phenomena. For a set of exogenous concept activations, the FCM/CWWs are iterated until a convergence of states is reached. The converged activations of the non-exogenous nodes are then represented by normalized distributions of word similarities over their corresponding vocabularies, thus providing predictions of the states of these nodes for the given inputs. In the depicted embodiment, the cognitive mapping module 406 resides on server 404 and utilizes network 402 to access corpus of expert narratives 414. In other embodiments, the cognitive mapping module 406 may be located on another server, computing device, or exist in a cloud computing system, provided the cognitive mapping module 406 has access to corpus of expert narratives 414 and expert computing device 410.

FIG. 2 depicts a flowchart of the operational steps 500 taken by a cognitive mapping module 406 to generate the FCM/CWW, in accordance with an embodiment of the present invention. FIG. 2 provides an illustration of one embodiment and does not imply any limitations regarding a computing environment in which different embodiments may be implemented. Many modifications to the depicted flowchart may be made.

In step 502 the cognitive mapping module 406 reviews the corpus of expert narratives 414. Through manual review, a natural language processing system, or an external program/service/system, the cognitive mapping module 406 reviews the corpus of expert narratives 414 to identify information related to and relevant to the FCM/CWW or to a specific node, either present in the FCM/CWW or being incorporated into the FCM/CWW. This information is generally collected from the corpus of expert narratives 414 or data previously gathered, processed, and stored in database 408. Information collected from the corpus of expert narratives 414 is processed, identified, categorized, and stored in database 408 or in external databases. In some embodiments, the corpus of expert narratives 414 is processed by multiple different methods, wherein an external program or service may perform an initial process on the corpus of expert narratives 414, wherein a manual review may be performed to further process the information. In other embodiments, the functions or processes may be a form of, but not limited to, artificial intelligence, neural network, deep learning, reinforcement learning, Bayesian learning, or a combination thereof, which is then further reviewed by experts or manual reviewers to identify specifics of the information.

In some embodiments, this process is continuously occurring as the corpus of expert narratives 414 is expanding, being modified, or changing. In one embodiment, where the FCM/CWW is directed towards applications such as macro-economics, the continuous creation of new information, and real-time events lead to a constant evolving corpus of expert narratives 414. This can involve both computer review and human review based on the computer reviewed material reaching a threshold value or understanding of the narratives.

In step 504, cognitive mapping module 406, extracts the concepts from the reviewed corpus of expert narratives 414. Once the corpus of expert narratives 414 is reviewed, the cognitive mapping module 406 extracts specific concepts from the corpus of expert narratives 414 which are then incorporated into the node(s). The extracted concepts may be words and/or phrases used within the reviewed corpus of expert narratives 414, date and time information associated with the reviewed corpus of expert narratives 414, or other information or concepts which are identified as relevant from within the reviewed corpus of expert narratives 414. These extracted concepts are stored in individual vocabularies or banks which are associated with specific terms, topics, or concepts that are likely to become nodes within the FCM. In some embodiments these vocabulary banks are single words, or a multitude of words, terms, phrases, and the like which are associated with and related to the node topic. In some embodiments, the word or phrases are assigned values. These values are generated from specific vocabularies. The cognitive mapping module 406 generates a mathematical representation based on the vocabulary and the extracted concepts. In some embodiments the cognitive mapping module 406 processes word descriptors of the reviewed corpus of expert narratives 414 based on the extracted node. The cognitive mapping module 406 associates a vocabulary or word descriptors of reviewed corpus of expert narratives 414 to a specific node for the later aggregation functions to be performed.

In decision 506, the cognitive mapping module 406 determines if a concept or topic was previously incorporated into the cognitive map through an analysis of all existing nodes in the map(s). The cognitive mapping module 406 is able to determine if this concept or topic was previously incorporated into the FCM, is present in another FCM, or has not been incorporated into an FCM. If the cognitive mapping module 406 determines that the concept was previously incorporated into the FCM (YES), the cognitive mapping module 406 adjusts the relationship between the FCM and the previously incorporated node. If the cognitive mapping module 406 determines that the concept was not previously incorporated into the FCM (NO), the cognitive mapping module 406 incorporates the node where appropriate into the FCM. In some instances, topics or concepts may be similar to previously incorporated nodes. In these instances, the cognitive mapping module 406 may merge the two nodes or require human intervention to assist to determine if a new node needs to be created or the nodes can be merged.

In step 508, the cognitive mapping module 406 incorporates the node into the FCM/CWW. The node that is incorporated into the FCM/CWW is either an exogenous node, or a non-exogenous node. An exogenous mode is a node which is affects other non-exogenous nodes but is not affected by other nodes in a particular FCM/CWW. In some embodiments, it may be an independent node, while in others, its state may be determined by a node in another FCM/CWW. An exogenous node is assigned a fixed state for a given iteration of the FCM/CWW. A non-exogenous node is a node that is affected by at least one other node in the particular FCM/CWW. Thus, a non-exogenous node is not assigned a fixed state in a given iteration. In some embodiments, the node may be a new node integrated into the FCM/CWW or an update of a previously existing node in the FCM/CWW.

In step 510 the cognitive mapping module 406 establishes the relationships between the FCM/CWW and the incorporated node. These relations are either positively or negatively causal relationships that exist between at least two nodes. Based on the reviewed corpus of expert narratives 414, the extracted concepts, the word descriptors, and the words/concepts/topics the node represents, the cognitive mapping module 406 determines the positive or negative causal relationships between the two or more nodes. In some embodiments, this causal relationship is determined manually. The cognitive mapping module 406, establishes a relationship between the incorporated node and the FCM/CWW (shown in FIG. 4). The relationship between the incorporated node and the FCM/CWW includes at least one word or phrase describing the strength of the relationship(s), and an activation of the relationships. As new nodes are incorporated into the FCM/CWW, the vocabularies, node states, node relationships, may change or be modified.

In step 512, the cognitive mapping module 406 adjusts the relationship between the FCM and the previously incorporated, but recently reviewed node. The node may be related to a topic, idea, or piece of semantic data that was previously incorporated into the current FCM/CWW or any number of previously created, associated or non-associated FCM/CWWs. Through the discovery that the present concept was previously incorporated, the cognitive mapping module 406 is able further to increase the strength between the concept and other associated concepts. This may be through adjusting a value or score applied to the concept or creating additional links between the concepts, which may transcend into previously unlinked concepts or FCMs/CWW. This could have a ripple effect, thereby altering the concepts values or scores associated in the present FCM/CWW or any other associated FCM/CWW. Through this additional concept being incorporated into the FCM/CWW, it may be included as an exogenous node or a non-exogenous node. This is where the iteration of the present FCM/CWW may be adjusted based on the number of other nodes or concepts which the new concept affects and the degree at which it affects these other nodes.

A link between two nodes indicates a direct causal relation. The sign of the causal relationship is positive if high activations of the source node increase the activation of the destination node and is negative if high activations of the source node decrease the activation of the destination node.

These relationships, which are established as either positive or negative, also have a corresponding degree of strength. Through the ability to assign a word value to the strength of the relationship (e.g. “moderately high”) the influence of each relationship has corresponding effect on the probability and forecast calculations. In some embodiments, the relationship value calculation is trained, wherein the cognitive mapping module 406 and other machine learning models are then capable of locating relevant data of these nodes and new nodes and establishing the relationship.

The generation of the relationship is determined by the cognitive mapping module 406 and the use of the learning technology to determine the association between the nodes. In other embodiments, the relationship is determined by a user at the expert computing device 410. These relationships are stored in database 408.

In some embodiments, multiple FCM/CWWs may be created where different relationships are built between nodes based on various factors, such as, but not limited to, the client's request. In some embodiments, in addition to the creation of the relationship between the nodes, the relationship is analyzed to determine a positive or negative causal link between the nodes. These links may have various descriptions applied to them to further identify the positive or negative attributes of the casual links. In some embodiments of the FCM/CWW that is created, each node (both exogenous and non-exogenous) may be based on sub-FCM/CWWs.

FIG. 6 depicts a diagram of an FCM/CWW cognitive map 600, in accordance with an embodiment of the present invention. The FCM/CWW 600 shows an example of what a particular FCM/CWW may look like, wherein there are both exogenous 601 and non-exogenous nodes 602 and 603. The exogenous nodes 601 are identified in one color and the non-exogenous nodes 602 and 603 are identified in two colors. The connection 604 between the nodes is also shown indicating the “positive” and “negative” association between the nodes as well as a value identifying the affect the node has. The color of the non-exogenous nodes 602 and 603 may be based on the client and the focus of that specific client. For example, the nodes shown may be the only nodes which are connected to the nodes 603 through two degrees of separation. In the depicted embodiment, FED POLICY RATE HIKE and FED BALANCE SHEET INCREASES are the focus, hence the different color of these two non-exogenous nodes 603 when compared to the other non-exogenous nodes 602. This assists in improving the visualization of the FCM/CWW 600.

This image is shown as one embodiment of the visual depiction of the FCM/CWW 600. The visuals of the map can be altered based on the client and the client's topic of interest. In its entirety, the FCM/CCW 600 may be an extensive map of hundreds of nodes, all interconnected. For improving the visualization of the massively generated FCM/CCW 600 and providing the client with a readable and specific visual, the “unnecessary” portions of the map are easily hidden based on the non-exogenous nodes 603, the nodes which are directly (or indirectly to a predetermined degree of relationship) connected to the non-exogenous node(s) 603. The “unnecessary” nodes are hidden, as they may not represent topics or matters which are relevant or of interest to the client. However, these “unnecessary” nodes are still used in the calculation of the node states, but may not be necessary for the visual representation of the nodes 603.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

The foregoing descriptions of various embodiments have been presented only for purposes of illustration and description. They are not intended to be exhaustive or to limit the present invention to the forms disclosed. Accordingly, many modifications and variations of the present invention are possible in light of the above teachings will be apparent to practitioners skilled in the art. Additionally, the above disclosure is not intended to limit the present invention. In the specification and claims the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises”.

Although various representative embodiments of this invention have been described above with a certain degree of particularity, those skilled in the art could make numerous alterations to the disclosed embodiments without departing from the spirit or scope of the inventive subject matter set forth in the specification and claims. Joinder references (e.g. attached, adhered, joined) are to be construed broadly and may include intermediate members between a connection of elements and relative movement between elements. As such, joinder references do not necessarily infer that two elements are directly connected and in fixed relation to each other. Moreover, network connection references are to be construed broadly and may include intermediate members or devices between network connections of elements. As such, network connection references do not necessarily infer that two elements are in direct communication with each other. In some instances, in methodologies directly or indirectly set forth herein, various steps and operations are described in one possible order of operation, but those skilled in the art will recognize that steps and operations may be rearranged, replaced or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

Although the present invention has been described with reference to the embodiments outlined above, various alternatives, modifications, variations, improvements and/or substantial equivalents, whether known or that are or may be presently foreseen, may become apparent to those having at least ordinary skill in the art. Listing the steps of a method in a certain order does not constitute any limitation on the order of the steps of the method. Accordingly, the embodiments of the invention set forth above are intended to be illustrative, not limiting. Persons skilled in the art will recognize that changes may be made in form and detail without departing from the spirit and scope of the invention. Therefore, the invention is intended to embrace all known or earlier developed alternatives, modifications, variations, improvements and/or substantial equivalents.

What is claimed is:

1. A computer-implemented method for generating a cognitive map, comprising:
identifying, by one or more processors, a subject matter node, wherein it is determined if the subject matter is pre-existing in a cognitive map;
incorporating, by one or more processors, the subject matter node into the cognitive map;
establishing, by one or more processors, a relationship between the subject matter node and the pre-existing nodes, where the relationship is determined based on the subject matter node relative to the pre-existing nodes;
categorizing, by one or more processors, the subject matter node as an exogenous or a non-exogenous node; and
generating, by one or more processors, a graphical representation of the cognitive map.

2. The computer-implemented method of claim 1, wherein the generation of the cognitive map further comprises, selecting, by one or more processors, a portion of the cognitive map relative to a selected non-exogenous node.

3. The computer-implemented method of claim 1, wherein if it is determined that the subject matter is pre-existing in the cognitive map, adjusting, by one or more processors, a node related to the subject matter.

4. The computer-implemented method of claim 3, further comprising, iterating, by one or more processors, the cognitive map based on the adjusted node.

5. The computer-implemented method of claim 1, further comprising, identifying, by one or more processors, if an exogenous node has a positive or negative affect on an exogenous node.

6. The computer-implemented method of claim 1, wherein the identified subject matter is collected, by one or more processors, from source material.

7. The computer-implemented method of claim 1, further comprising, collecting, by one or more processors, a plurality of source material, wherein the source material contain subject matters.

8. The computer-implemented method of claim 7, further comprising, processing, by one or more processors, a source material to determine the subject matter of the source material.

9. The computer-implemented method of claim 8, wherein the processing is determined in response to validation information provided by one or more subject matter experts.

10. A computer program product,
the computer program product comprising a computer readable storage medium having program instructions embodied therewith, the program instructions executable by a computing device to cause the computing device to:
review a piece of source material, wherein it is determined by one or more subject matter experts if the piece of source material has at least one subject matter;
incorporating the at least one subject matter into a cognitive map,
determining a causal relationship between the at least one subject matter and the pre-existing subject matters in the cognitive map; and
generating a visual representation of the cognitive map.

11. The computer program product of claim 10, wherein it is determined one of the at least one subject matters previously existed in the cognitive map, further comprising, adjusting the node associated with the subject matter and the affect of the node to all connected nodes.

12. The computer program product of claim 10, wherein the generation of the visual representation of the cognitive map further comprises identifying a predetermined section of the cognitive map to depict.

13. The computer program product of claim 12, further comprising, depicting, the relationship between the depicted nodes of the cognitive map, wherein the relationship is either positive or negative.

14. The computer program product of claim 10, further comprising, identifying the different type of nodes in the visual representation of the cognitive map, wherein the exogenous nodes are distinguished from the non-exogenous nodes.

15. The computer program product of claim 10, further comprising, receiving knowledge and information developed by one or more subject matter expert in association with the subject matter of the source material.

16. A system comprising:
a CPU, a computer readable memory and a computer readable storage medium associated with a computing device;
program instructions to identify a subject matter, wherein the subject matter is related to a topic;
program instructions to determine if the topic is previously identified within a map, wherein the map is comprised of a plurality of nodes related to individual topics, and it is determined that the topic is not identified within the map;
program instructions to incorporate the topic into the map as a subject matter node;
program instructions to establish at least one causal relationship between the subject matter node and the plurality of nodes, where the causal relationship is determined based on the topic of the subject matter node and the topics of the plurality of nodes;
program instructions to categorize the subject matter node as an exogenous or a non-exogenous node, wherein the determination is based on the at least one causal relationship between the subject matter node and the plurality of nodes; and
program instructions to generate a graphical representation of the cognitive map.

17. The system of claim 16, wherein the generation of the graphical representation of the cognitive map further comprises, selecting, by one or more processors, a set of the plurality of nodes.

18. The system of claim 16, further comprising, program instructions to identify the causal relationship between each connected node, wherein the causal relationship is either positive or negative.

19. The system of claim 16, wherein if it is determined that the topic was previously identified within the map, further comprising, amending a set of values associated with the node and the causal relationships of the node.

20. The system of claim 16, wherein the selected set of the plurality of nodes is based on at least one non-exogenous node and the degree of relationship between the at least one non-exogenous node and the other nodes in the map.
